(19) United States
(12) Patent Application Publication
(10) Pub. No.: US 2022/0008909 A1
(43) Pub. Date: Jan. 13, 2022

(54) PIPETTE AND PIPETTE TIP

(71) Applicant: Mettler-Toledo Rainin, LLC, Oakland, CA (US)

(72) Inventor: James S. Petrek, Danville, CA (US)

(21) Appl. No.: 16/922,814

(22) Filed: Jul. 7, 2020

(51) Int. Cl. B01L 3/02

(52) U.S. Cl. CPC B01L 3/0217

(57) ABSTRACT

A pipette and sealing pipette tip can include features for generating a secure mounting engagement between the pipette and pipette tip without the need for protrusions on the pipette tip used for providing an interference fit and avoiding the need for a separate air-tight seal directly between the piston and shaft of the pipette.

### FIELD OF THE INVENTION

The present inventions relate to air displacement pipettes and sealing tips for such pipettes, for example, air displacement pipettes in which sealing between a disposable or reusable sealing tip and a piston within the pipette is accomplished via structures integral to the sealing tips.

### BACKGROUND OF THE INVENTION

Handheld pipettes are commonly used to dispense or transfer small but accurately measured quantities of liquids. Air displacement pipettes are the most common variety of handheld pipettes. In an air displacement pipette, a controllable piston is mounted for movement axially within a chamber in the pipette; the piston moves in response to either manual or motorized electronic control. Typically, the piston moves in a chamber in the liquid end, or shaft, of the pipette, to which disposable pipette tips may be mounted.

An air tight seal is formed between the piston and the shaft of a typical pipette. With such a seal in place, axial movement of the piston will vary the size of the airspace within the shaft. Moving the piston downward, into the shaft, reduces the airspace and forces air out of the shaft through an open distal end. Moving the piston upward, out of the shaft, increases the airspace and causes air to be drawn into the shaft through the open end of the pipette.

The seal between the piston and the shaft can be formed with a compressed O-ring or a similar structure, fabricated from a material that provides satisfactory long-term performance. For example, some piston seal structures are made from polyethylene combined with PTFE, which has been found to offer good sealing performance and wear resistance and reliability over a period of months, although such seals do tend to break down and leak over the course of time. Other configurations are possible, including various dry or lubricated seals.

In order to use such a pipette for sampling liquids, for example, a pipette tip, typically disposable but can also be reusable, is sealed to the open distal end of the shaft. Sealed as such, as the piston is moved within the shaft, air—or a measured quantity of liquid equal in volume to the displaced air—is drawn into or forced out of the open end of the tip. With both the piston and the tip sealed to the shaft, the only entry and exit path should be the distal open end of the pipette tip. As such, an air displacement pipette can be used to make accurate and precise measurements, and to move carefully calibrated quantities of liquids.

Many typical pipette tips attach to the shaft of a pipette through a simple friction fit. The two most common and commercially successful pipette tip fitting standards are the standard conical mount and the LTS RTM system offered by Rainin Instrument, LLC. In both cases, the friction fit between the shaft and the tip also enables an air-tight seal. One version of the LTS pipette tip is described in U.S. Pat. No. 6,168,761, which is hereby incorporated by reference as though set forth in full. The LTS tip, as shown, seals against the pipette shaft along a single, thin, annular sealing band, and the commercial success of the LTS system demonstrates that successful and repeatable sealing, with low friction, can be accomplished with such a configuration.

Alternative tip mounts have been attempted but have not met with great commercial success. For example, Matrix Technologies Corporation offers a tip with tabs that lock into corresponding features in the pipette shaft. See U.S. Pat. No. 7,641,859 to Cote et al. Viaflo Corporation offers a solution that includes a lobed shaft that locks into corresponding features within the tip. See U.S. Pat. No. 7,662,343 to Mathus et al. Sorenson BioScience sells a dual-material pipette tip for traditional pipette shafts that employs a second material to optimize the mount. These dual-material tips have a rigid polypropylene distal end for handling liquids, and a soft thermoplastic elastomeric mount portion overmolded thereon. See U.S. Patent Application Publication No. 2008/0078258 to Price et al. Tips for robotic applications from Apricot Designs have external seal rings that seal to the inner barrel of a tip holder. See U.S. Pat. No. 6,780,381.

All of the above alternative pipette tips share a common attribute; not only do they require a seal between the tip and the shaft, but they also require a seal between the shaft and the piston. Two-seal designs present two potential points of failure. The seal between the tip and the shaft is replaced every time a tip is discarded and replaced with a new one, but the seal in the pipette is replaced or serviced much less frequently and requires partial disassembly of the pipette itself. Such service is often performed along with laboratory re-calibration, a package of services that takes significant time during which the pipette is unavailable for use. Delayed service or replacement of the seal in the pipette may lead to leaks and other failures, which in turn may lead to inaccuracy in liquid measurement or failure in pipetting operations.

In general, seal failure (such as wear, splitting, other damage, misalignment, dislodgment, corrosion, or contamination) is a common cause of pipetting failure, e.g., inaccurate measurements. These failures can lead to failed outcomes, and may be difficult to identify in advance, or even as pipetting is ongoing. Wear and damage to the shaft in the tip mount region can also result in failures, and for this reason, plastic pipette shafts are also replaced from time to time.

These problems may be mitigated to some extent by performing frequent calibrations and having the pipette serviced often, at intervals significantly shorter than the expected required maintenance cycles. Best practices in this regard typically involve regular seal replacement, even if it does not appear necessary. Such maintenance often involves fairly significant teardown of the pipette, which requires dedicated labor and calibration upon reassembly which can potentially render a pipette out of service for a significant period of time.

Another consequence of the traditional pipette configuration—with the lower end of the piston moving within a cavity in the shaft, which is in turn connected to a pipette tip—is the existence of significant empty ullage space over liquid in the tip. More specifically, a substantial cushion of air exists between the piston and the liquid level in the tip in such traditional pipette configurations. This cushion of air can be compressed and expanded when acted upon, serving as a “spring” between the position of the piston and the liquid level. This additional movement—compression and expansion—is undesirable, and can lead to volume measurement inaccuracies. Moreover, the cushion of air can drive liquid evaporation into the air, condensation, eating, and cooling, and resulting expansion and contraction effects, which may further effect the accuracy of pipetting operations. High accuracy may still be possible, but it is largely dependent on appropriate technique being employed by the user.

In some traditional pipette tips, protection from cross-contamination is provided by a disc or cylinder of porous filter media disposed near the proximal end, between the mount of the pipette tip and the liquid handling portion. The filter allows air to pass through, but inhibits aerosols and liquids. Such filtered tips must be larger than unfiltered tips for the same liquid volume capacity (because of the space occupied by the filter, plus a gap between the filter and the liquid level). Filters also tend to impede airflow, and are relatively inefficient and expensive to produce and insert into pipette tips. Because of this, filtered pipette tips are generally more expensive than their unfiltered counterparts.

### SUMMARY OF THE INVENTIONS

An aspect of at least one of the inventions disclosed herein includes the realization that a pipette tip including a reduced thickness sealing and mounting lip, at its proximal end, can achieve both secure mounting to a pipette, with low insertion force, as well as sealing to a slidable piston within the pipette. For example, a pipette tip can include a reduced thickness lip extending proximally from the proximal end of the pipette tip, having a wall thickness substantially thinner than the wall thickness of the remaining portion of the mount portion of the pipette tip. The reduced thickness lip can provide some diametric elasticity so as to conform to a space between the inner surface of the shaft and an outer surface of the piston, so as to generate a secure mounting engagement with the pipette shaft, as well as a reliable air seal with the outer surface of the outer piston on its inner surface. Further, in some embodiments, the reduced thickness lip can provide some elastic deformation in the form of buckling. For example, a reduced thickness lip can be considered as forming a thin walled columnar structure. As such, when the reduced thickness lip of the pipette tip, in accordance with some embodiments, is inserted into a pipette and into engagement between a pipette shaft and a pipette piston, the reduced thickness lip can slightly deform in one or more ways to achieve both secure mounting and a reliable air seal with the piston.

For example, the reduced thickness lip, forming a thin-walled columnar structural member, can buckle slightly, for example, elastically deform outwardly in a position at a point distal from the proximal most edge of the reduced thickness lip. Such a reaction can help ensure a reliable air seal against the sliding piston.

Additionally, in some embodiments, the reduced thickness lip, again which can be considered as forming a thin-walled columnar structure, can bulge slightly in response to a compressive force exerted axially against the proximal end of the reduced thickness lip. Similarly, such bulging can help increase an inward sealing force supporting a reliable seal between the reduced thickness lip and the piston of the pipette.

Another aspect of at least one of the inventions disclosed herein includes the realization that a pipette tip can be provided with a thin-walled sealing lip at its proximal end and can achieve both a secure mounting engagement with a pipette shaft and a seal between the inner surface of the thin-walled lip and the outer surface of a piston of the pipette. In some configurations, the thin-walled sealing lip can be pinched between the inner surface of the pipette shaft and the outer surface of the pipette piston. Although the flexibility of the reduced thickness lip might result in generally equal forces acting between the lip and the outer surfaces of the piston and the lip with the inner surface of the shaft, the outer contact patch between the outer surface of the reduced thickness lip and the inner surface of the shaft can be larger than the inner contact patch between the inner surface of the reduced-thickness lip and the outer surface of the piston because the radius of curvature of the outer surface of the lip is larger than the radius of curvature of the inner surface of the lip. Thus, in such a configuration, the reduced-thickness lip can achieve a secure mounting engagement with the inner surface of the shaft with sufficient strength to overcome the frictional sliding forces between the inner surface of the reduced-thickness lip and the outer surface of the piston, even if the coefficient of friction acting at the inner and outer contact patches are the same.

In some embodiments, the reduced thickness sealing lip can achieve one or more of the above-noted advantages in configurations where the inner surface of the mounting portion of the pipette tip has a generally uniform inner diameter distal from and including the reduced thickness sealing lip, where the outer surface of the mounting portion of the pipette tip has a change in the outer diameter, from the distal portion of the mounting portion to the reduced thickness lip. Further, in some embodiments, the outer surface of the reduced thickness sealing lip can be parallel to the inner surface of the reduced thickness sealing lip. In some embodiments, the proximal end of the reduced-thickness sealing lip can be tapered slightly inwardly.

Another aspect of at least one of the inventions disclosed herein includes the realization that a reduced thickness lip of a pipette tip can include a stepped configuration transitioning from a first distal portion having a large inner and outer diameter and a second proximal portion, including smaller outer and inner diameters than the respective distal portions. The stepped configuration can provide some additional advantages. For example, the stepped configuration can help localize the sealing engagement of the inner surface of the reduced thickness lip with the outer surface of the piston so it is limited to only the smaller diameter proximal portion of the reduced thickness sealing lip. Additionally, the stepped configuration can provide more consistent buckling deformation of the reduced thickness sealing lip when it is engaged to the pipette. For example, the transition between the distal and proximal portions of the reduced thickness sealing lip can structurally form a preferred buckling location on the lip. In the context of the reduced thickness sealing lip being considered a thin-walled column, the transition from the larger diameter to the smaller diameter can define an initiation point of a buckling deformation when the reduced-thickness lip is subjected to a compressive load.

For example, where the thickness of the reduced thickness lip is generally uniform across the distal and proximal portions, the transition area from the larger diameter to the smaller diameter can react in a way so as to buckle in a predictable and repeatable point along the reduced-thickness sealing lip.

In some embodiments, a hand-held pipette can include a pipette shaft having an inner surface and a pipette piston being mounted for reciprocal motion relative to the inner surface of the shaft. The inner surface of the pipette shaft and the outer surface of the pipette piston can be spaced so as to define a first annular channel having a first width at a pipette tip receiving portion. The pipette shaft can include an enlarged portion disposed distally from the proximal portion, wherein the distal portion includes a larger diameter than the proximal portion. Such a construction can optionally provide additional benefits by allowing for freer expansion of distal portions of a pipette tip, for example, where a pipette tip is inserted into the annular channel with sufficient force to cause some elastic expansion under a compressive load.

In some embodiments, the pipette includes a tapered shoulder at a distal end of the annular channel. Such a tapered shoulder can optionally provide additional benefits, for example, by providing a guiding surface along which a proximal end of a pipette tip can be inserted so as to guide the proximal end of the pipette tip into the channel during insertion.

Thus, in accordance with some embodiments, an air displacement pipette can comprise an elongated tip-mounting shaft having a distal end and an interior surface portion comprising a first material with a first surface roughness defining a first surface characteristic. A piston can be mounted for axial movement within the shaft, the piston having an outer surface portion comprising a second material with a second surface roughness defining a second surface characteristic. An annular channel can be defined between the elongated tip-mounting shaft and the piston, the annular channel having a distal portion with a first larger cross sectional shape tapering to a proximal portion having a second smaller, uniform cross sectional shape, the second smaller, uniform cross section portion being defined between the interior surface portion of the shaft and the outer surface portion of the piston, the proximal portion of the annular channel having a width of no more than 0.5 mm and having a depth of at least 2 mm. Additionally, a pipette tip can have a generally elongated tubular configuration and comprising a mount portion including a distal portion and a proximal end portion, the distal portion comprising a first wall thickness, the proximal end portion having a uniform cross section portion comprising a second wall thickness smaller than the first wall thickness and being between 0.1 mm and 0.3 mm, the proximal end portion having a length of at least 2 mm, the proximal end portion having a pipette tip outer surface comprising a third material and a third surface roughness defining a third surface characteristic, and wherein the proximal end portion also comprises a pipette tip inner surface comprising the third material and a fourth surface roughness defining a fourth surface characteristic. The first and third surface characteristics can define a static coefficient of friction that generates a static frictional force in use and wherein the second and fourth surface characteristics define a maximum coefficient of friction that generates a maximum frictional force in use that is less than the static frictional force. When the pipette tip is mounted on the elongated tip-mounting shaft, the proximal end portion of the pipette tip extends into the annular channel between the piston and the elongated tip-mounting shaft, the piston penetrates the proximal end portion of the pipette tip and is axially movable within the mount portion of the tip while the pipette tip outer surface remains fixed relative to the interior surface portion of the shaft, the pipette tip inner surface forms an air tight seal against the outer surface portion of the piston, and an air volume is maintained between a distal face of the piston and any liquid in the pipette tip and displaced by axial movement of the piston. There is no seal forming an air-tight seal directly between the elongated tip-mounting shaft and the piston at a location spaced from the annular channel.

In some embodiments, there is no protruding structure on the pipette tip outer surface of the proximal end portion of the pipette tip.

In some embodiments, the pipette tip outer surface does not engage any portion of the annular channel with a snap fit.

In accordance with other embodiments, an air displacement pipette can comprise an elongated tip-mounting shaft having a distal end and an interior surface portion comprising a first surface. A piston can be mounted for axial movement within the shaft, the piston having an outer surface portion comprising a second surface. An annular channel can be defined between the elongated tip-mounting shaft and the piston, the annular channel having a distal portion with a first larger cross sectional shape tapering to a proximal portion having a second smaller, uniform cross sectional shape, the second smaller, uniform cross section portion being defined between the interior surface portion of the shaft and the outer surface portion of the piston. A pipette tip can have a generally elongated tubular configuration and comprising a mount portion including a distal portion and a proximal end portion, the distal portion comprising a first wall thickness, the proximal end portion having a uniform cross section portion comprising a second wall thickness smaller than the first wall thickness, the proximal end portion having a pipette tip outer surface comprising a third surface, and wherein the proximal end portion also comprises a pipette tip inner surface comprising a fourth surface. The first and third surfaces can generate a static frictional force in use and wherein the second and fourth surfaces generate a maximum frictional force in use that is less than the static frictional force, and wherein there is no protruding structure on the pipette tip outer surface of the proximal end portion of the pipette tip.

In some embodiments, the pipette tip outer surface does not engage any portion of the annular channel with a snap fit.

In some embodiments, the first surface comprises a first material with a first surface roughness defining a first surface characteristic, the second surface comprising a second material with a second surface roughness defining a second surface characteristic, the third surface comprising a third material and a third surface roughness defining a third surface characteristic, the fourth surface comprising the third material and a fourth surface roughness defining a fourth surface characteristic, wherein the first and third surface characteristics define a static coefficient of friction that generates a static frictional force in use and wherein the second and fourth surface characteristics define a maximum coefficient of friction that generates a maximum frictional force in use that is less than the static frictional force.

In some embodiments, the proximal portion of the annular channel comprises a width of no more than 0.5 mm and having a depth of at least 2 mm.

In some embodiments, the wall thickness of the proximal end portion is between 0.1 mm and 0.4 mm, the proximal end portion having a length of at least 2 mm.

In some embodiments, there is no seal forming an air-tight seal directly between the elongated tip-mounting shaft and the piston at a location spaced from the annular channel.

In other embodiments, an air displacement pipette can comprise an elongated tip-mounting shaft having a distal end and an interior surface portion comprising a first surface. A piston can be mounted for axial movement within the shaft, the piston having an outer surface portion comprising a second surface. An annular channel can be defined between the elongated tip-mounting shaft and the piston, the annular channel having a proximal portion defined between the interior surface portion of the shaft and the outer surface portion of the piston. A pipette tip can have a generally elongated tubular configuration and comprising a mount portion including a distal portion and a proximal end portion, the distal portion comprising a first wall thickness, the proximal end portion comprising a second wall thickness smaller than the first wall thickness, wherein there is no protruding structure on an outer surface of the proximal end portion of the pipette tip, and wherein an outer surface of the proximal end portion is frictionally fixed to the first surface of the shaft during use while the second surface of the piston forms a sliding, air tight seal with an inner surface of the proximal end portion of the pipette tip during use.

In some embodiments, the outer surface of the pipette tip does not engage any portion of the annular channel with a snap fit.

In some embodiments, the first surface comprises a first material with a first surface roughness defining a first surface characteristic, the second surface comprising a second material with a second surface roughness defining a second surface characteristic, the third surface comprising a third material and a third surface roughness defining a third surface characteristic, the fourth surface comprising the third material and a fourth surface roughness defining a fourth surface characteristic, wherein the first and third surface characteristics define a static coefficient of friction that generates a static frictional force in use and wherein the second and fourth surface characteristics define a maximum coefficient of friction that generates a maximum frictional force in use that is less than the static frictional force.

In some embodiments, the proximal portion of the annular channel comprises a width of no more than 0.4 mm and having a depth of at least 2 mm.

In some embodiments, the wall thickness of the proximal end portion is between 0.1 mm and 0.3 mm, the proximal end portion having a length of at least 2 mm.

In some embodiments, there is no seal forming an air-tight seal directly between the elongated tip-mounting shaft and the piston at a location spaced from the annular channel.

In some embodiments, the proximal portion of the annular channel comprises a uniform cross sectional shape.

In some embodiments, the annular channel comprises a distal portion with a first larger cross sectional shape tapering to a second smaller cross sectional shape.

In some embodiments, the proximal end portion comprises a pipette tip outer surface comprising a third surface, and wherein the proximal end portion also comprises a pipette tip inner surface comprising a fourth surface and wherein the first and third surfaces generate a static frictional force in use and wherein the second and fourth surfaces generate a maximum frictional force in use that is less than the static frictional force.

In some embodiments, the proximal end portion comprises an intermediate step, dividing the proximal end portion into a distal part and a proximal part, the pipette tip outer surface being disposed on the distal part and the pipette tip inner surface being disposed on the proximal part, and wherein the proximal part comprises an outer diameter that is less than an outer diameter of the pipette tip outer surface.

In other embodiments, a disposable pipette tip can be configured for use with an air displacement pipette having an elongated tip-mounting shaft with an interior surface, a piston having an outer surface and mounted for axial movement within the shaft, and an annular channel defined between the interior surface of the mounting shaft and the outer surface of the piston, the annular channel having substantially parallel walls. The pipette tip can comprise a liquid handling portion comprising an elongated, tubular liquid handling body with a first distal end and a first proximal end, and an orifice disposed at the first distal end. A mount portion can extend from the first proximal end of the liquid handling portion, the mount portion including a distal portion and a proximal end portion, the distal portion comprising a first wall thickness, the proximal end portion having a uniform cross section portion comprising a second wall thickness smaller than the first wall thickness and being between 0.1 mm and 0.3 mm, the proximal end portion having a length of at least 2 mm, the proximal end portion having a pipette tip outer surface comprising a first material and a first surface roughness defining a first surface characteristic, and wherein the proximal end portion also comprises a pipette tip inner surface, parallel to the pipette tip outer surface, and comprising the first material and a second surface roughness defining a second surface characteristic, wherein there is no structural protrusion on the pipette tip outer surface of the proximal end portion. The first surface characteristic can produce a static coefficient of friction that generates a static frictional force in use when the pipette tip outer surface is in contact with the interior surface of the elongated tip mounting shaft of a pipette and wherein the second surface characteristic produces an air tight seal and a maximum coefficient of friction that generates a maximum frictional force in use when the pipette tip inner surface is in contact with the outer surface of the piston of a pipette, wherein the maximum frictional force is less than the static frictional force, thereby allowing the piston of the pipette to slide relative to the pipette tip inner surface while the pipette tip outer surface remains fixed to the interior surface of the elongated tip mounting shaft by action of the static frictional force.

In some embodiments, there is no protruding structure on the pipette tip outer surface of the proximal end portion of the pipette tip.

In some embodiments, the pipette tip outer surface does not engage any portion of the annular channel with a snap fit.

In some embodiments, there is no protruding structure on the pipette tip outer surface of the proximal end portion of the pipette tip.

In some embodiments, the pipette tip outer surface does not engage any portion of the annular channel with a snap fit.

In other embodiments, a pipette tip can be configured for use with an air displacement pipette having an elongated tip-mounting shaft, a piston, and an annular channel defined between the mounting shaft and the piston. The pipette tip can comprise a liquid handling portion comprising an elongated, tubular liquid handling body with a first distal end and a first proximal end, and an orifice disposed at the first distal end. A mount portion can extend from the first proximal end of the liquid handling portion, the mount portion including a distal portion and a proximal end portion, the distal portion comprising a first wall thickness, the proximal end portion comprising a second wall thickness smaller than the first wall thickness and being between 0.1 mm and 0.4 mm, the proximal end portion having a length of at least 2 mm, the proximal end portion having a pipette tip outer surface comprising a first material and a first surface roughness defining a first surface characteristic, and wherein the proximal end portion also comprises a pipette tip inner surface, parallel to the pipette tip outer surface, and comprising the first material and a second surface roughness defining a second surface characteristic. The first surface characteristic can produce a static frictional force in use when the pipette tip outer surface is in contact with the tip mounting shaft of a pipette and wherein the second surface characteristic produces an air tight seal and a maximum frictional force in use when the pipette tip inner surface is in contact with the piston of a pipette, wherein the maximum frictional force is less than the static frictional force.

In some embodiments, there is no protruding structure on the pipette tip outer surface of the proximal end portion of the pipette tip.

In some embodiments, the pipette tip outer surface does not engage any portion of the annular channel with a snap fit.

In some embodiments, the proximal end portion comprises a uniform cross section extending at least 2 mm from a terminal end of the proximal end portion.

In some embodiments, there is no structural protrusion on the pipette tip outer surface of the proximal end portion.

In some embodiments, the first and second surface characteristics are configured such that the magnitudes of the maximum and static frictional forces allow the piston of the pipette to slide relative to the pipette tip inner surface while the pipette tip outer surface remains fixed to the interior surface of the elongated tip mounting shaft by action of the static frictional force.

In some embodiments, the proximal end portion comprises an intermediate step, dividing the proximal end portion into a distal part and a proximal part, the pipette tip outer surface being disposed on the distal part and the pipette tip inner surface being disposed on the proximal part.

In some embodiments, the proximal part comprises an outer diameter that is less than an outer diameter of the pipette tip outer surface.

In other embodiments, a pipette tip for use with an air displacement pipette having an mounting shaft, and a piston, can comprise a liquid handling portion comprising an elongated, tubular liquid handling body with a first distal end and a first proximal end, and an orifice disposed at the first distal end. A mount portion can extend from the first proximal end of the liquid handling portion, the mount portion including a distal portion and a proximal end portion, the distal portion comprising a first wall thickness, the proximal end portion comprising a second wall thickness smaller than the first wall thickness, the proximal end portion having a pipette tip outer surface, and wherein the proximal end portion also comprises a pipette tip inner surface, substantially parallel to the pipette tip outer surface, wherein there is no protruding structure on the pipette tip outer surface of the proximal end portion of the pipette tip.

In some embodiments, the second wall thickness is between 0.1 mm and 0.3 mm.

In some embodiments, the second wall thickness is no more than 0.2 mm.

In some embodiments, the pipette tip outer surface does not engage any portion of the annular channel with a snap fit.

In some embodiments, the proximal end portion comprises a uniform cross section extending at least 2 mm from a terminal end of the proximal end portion.

In some embodiments, the first and second surface characteristics are configured such that the magnitudes of the maximum and static frictional forces allow the piston of the pipette to slide relative to the pipette tip inner surface while the pipette tip outer surface remains fixed to the interior surface of the elongated tip mounting shaft by action of the static frictional force.

In some embodiments, the proximal end portion comprises an intermediate step, dividing the proximal end portion into a distal part and a proximal part, the pipette tip outer surface being disposed on the distal part and the pipette tip inner surface being disposed on the proximal part.

In some embodiments, the proximal part comprises an outer diameter that is less than an outer diameter of the pipette tip outer surface.

In some embodiments, the second wall thickness is at least 0.1 mm, and the proximal end portion has a length of at least 2 mm.

In some embodiments, the pipette tip outer surface comprises a first material and a first surface roughness defining a first surface characteristic, and wherein the pipette tip inner surface comprises the first material and a second surface roughness defining a second surface characteristic, and wherein the first surface characteristic produces a static frictional force in use when the pipette tip outer surface is in contact with the tip mounting shaft of a pipette and wherein the second surface characteristic produces an air tight seal and a maximum frictional force in use when the pipette tip inner surface is in contact with the piston of a pipette, wherein the maximum frictional force is less than the static frictional force.

In other embodiments, an air displacement pipette can be configured for use with a disposable pipette tip having a generally elongated tubular configuration with a mount portion including a distal portion and a proximal end portion, the proximal end portion having a uniform cross section with parallel inner and outer surfaces. The pipette can comprise an elongated tip-mounting shaft having a distal end and an interior surface portion comprising a first material with a first surface roughness defining a first surface characteristic. A piston can be mounted for axial movement within the shaft, the piston having an outer surface portion comprising a second material with a second surface roughness defining a second surface characteristic. An annular channel can be defined between the elongated tip-mounting shaft and the piston, the annular channel having a distal portion with a first larger cross sectional shape tapering to a proximal portion having a second smaller, uniform cross sectional shape, the second smaller, uniform cross section portion being defined between the interior surface portion of the shaft and the outer surface portion of the piston, the proximal portion of the annular channel having a width of no more than 0.5 mm and having a depth of at least 2 mm. The first surface characteristic can define a static coefficient of friction that generates a static frictional force in use when the interior surface portion is in contact with an outer surface of a mounting portion of a pipette tip and wherein the second surface characteristic define a maximum coefficient of friction that generates a maximum frictional force in use when the outer surface portion of the piston is in contact with an inner surface of a mounting portion of a pipette tip, wherein the maximum frictional force is less than the static frictional force. When the pipette tip is mounted on the elongated tip-mounting shaft, the proximal end portion of the pipette tip extends into the annular channel between the piston and the elongated tip-mounting shaft, the piston penetrates the proximal end portion of the pipette tip and is axially movable within the mount portion of the tip while the pipette tip outer surface remains fixed relative to the interior surface portion of the shaft, the pipette tip inner surface forms an air tight seal against the outer surface portion of the piston, and an air volume is maintained between a distal face of the piston and any liquid in the pipette tip and displaced by axial movement of the piston. There is no seal forming an air-tight seal directly between the elongated tip-mounting shaft and the piston at a location spaced proximally from the annular channel.

In some embodiments, there is no protruding structure on the pipette tip outer surface of the proximal end portion of the pipette tip.

In some embodiments, the pipette tip outer surface does not engage any portion of the annular channel with a snap fit.

In other embodiments, an air displacement pipette can be configured for use with a disposable pipette tip having a proximal end portion with a pipette tip outer surface and a pipette tip inner surface. The pipette can comprise an elongated tip-mounting shaft having a distal end and an interior surface portion comprising a first material with a first surface roughness defining a first surface characteristic. A piston can be mounted for axial movement within the shaft, the piston having an outer surface portion comprising a second material with a second surface roughness defining a second surface characteristic. An annular channel can be defined between the elongated tip-mounting shaft and the piston, the annular channel having a distal portion with a first larger cross sectional shape tapering to a proximal portion having a second smaller, cross sectional shape, the second smaller, cross section portion being defined between the interior surface portion of the shaft and the outer surface portion of the piston. The first surface characteristic can define a static coefficient of friction that generates a static frictional force in use when the interior surface portion is in contact with an outer surface of a mounting portion of a pipette tip and wherein the second surface characteristic define a maximum coefficient of friction that generates a maximum frictional force in use when the outer surface portion of the piston is in contact with an inner surface of a mounting portion of a pipette tip, wherein the maximum frictional force is less than the static frictional force. There is no seal forming an air-tight seal directly between the elongated tip-mounting shaft and the piston at a location spaced proximally from the annular channel.

In some embodiments, there is no protruding structure on the pipette tip outer surface of the proximal end portion of the pipette tip.

In some embodiments, the pipette tip outer surface does not engage any portion of the annular channel with a snap fit.

In some embodiments, the proximal portion of the annular channel has a width of no more than 0.5 mm and has a depth of at least 2 mm.

In other embodiments, an air displacement pipette can be configured for use with a disposable pipette tip having a proximal end portion with a pipette tip outer surface and a pipette tip inner surface. The pipette can comprise a mounting shaft having a distal end and an interior surface portion, a piston mounted for axial movement within the shaft, the piston having an outer surface portion, and an annular channel defined between the elongated tip-mounting shaft and the piston, the annular channel having a distal portion with a first larger cross sectional shape tapering to a proximal portion having a second smaller, cross sectional shape, the second smaller, cross section portion being defined between the interior surface portion of the shaft and the outer surface portion of the piston. There is no seal forming an air-tight seal directly between the elongated tip-mounting shaft and the piston at a location spaced proximally from the annular channel.

In some embodiments, there is no protruding structure on the pipette tip outer surface of the proximal end portion of the pipette tip.

In some embodiments, the pipette tip outer surface does not engage any portion of the annular channel with a snap fit.

In some embodiments, the proximal portion of the annular channel has a width of no more than 0.5 mm and has a depth of at least 2 mm.

In some embodiments, when the pipette tip is mounted on the elongated tip-mounting shaft, the proximal end portion of the pipette tip extends into the annular channel between the piston and the elongated tip-mounting shaft, the piston penetrates the proximal end portion of the pipette tip and is axially movable within the mount portion of the tip while the pipette tip outer surface remains fixed relative to the interior surface portion of the shaft, the pipette tip inner surface forms an air tight seal against the outer surface portion of the piston, and an air volume is maintained between a distal face of the piston and any liquid in the pipette tip and displaced by axial movement of the piston.

In some embodiments, the interior surface portion of the mounting shaft comprises a first material with a first surface roughness defining a first surface characteristic, the outer surface of the piston comprising a second material with a second surface roughness defining a second surface characteristic, and wherein the first surface characteristic defines a static coefficient of friction that generates a static frictional force in use when the interior surface portion is in contact with an outer surface of a mounting portion of a pipette tip and wherein the second surface characteristic defines a maximum coefficient of friction that generates a maximum frictional force in use when the outer surface portion of the piston is in contact with an inner surface of a mounting portion of a pipette tip, wherein the maximum frictional force is less than the static frictional force.

Accordingly, a number of shortcomings of other known pipettes and tips are remedied by pipettes and tips according to the invention.

Other aspects and features of the invention will become apparent to those skilled in the art upon review of the following detailed description of exemplary embodiments along with the accompanying drawing figures.

### BRIEF DESCRIPTION OF THE DRAWINGS

In the following descriptions of the drawings and exemplary embodiments, like reference numerals across the several views refer to identical or equivalent features, and:

FIG. 1 is a perspective view of an embodiment of a handheld pipette with an embodiment of a sealing pipette tip mounted thereon;

FIG. 2 is an enlarged cross-sectional view of a first embodiment of the pipette of FIG. 1, and in particular, a first embodiment of the distal end of the pipette shaft, pipette piston, and pipette ejector sheath;

FIG. 3 is an enlarged schematic cross-sectional view of another embodiment of the pipette, and in particular, the distal end of the pipette shaft, pipette piston, and ejector sheath;

FIG. 4 is a perspective view of an embodiment of a sealing pipette tip which can be used with any of the pipettes and modifications illustrated in FIGS. 1-3;

FIG. 5 is another perspective view of the sealing pipette tip of FIG. 4;

FIG. 6 is a cross-sectional view of the sealing pipette tip of FIGS. 4 and 5;

FIG. 7 is an enlarged cross-sectional view of a mounting portion of the sealing pipette tip of FIG. 6;

FIG. 8 is an enlarged cross-sectional view of one side of the cross-section shown in FIG. 7;

FIG. 9 is an enlarged cross-sectional view of the sealing pipette tip of FIG. 4 inserted into the pipette of FIG. 1 prior to being securely mounted thereto;

FIG. 10 is an enlarged cross-sectional view of the sealing pipette tip of FIG. 4 fully inserted into the pipette of FIG. 12 with a reduced thickness lip of the pipette tip fully seated into a mounting recess of the pipette;

FIG. 11 is a cross-sectional view of the pipette tip of FIG. 4 inserted into the pipette of FIG. 1 as modified according to FIG. 3, prior to being fully seated therein;

FIG. 12 is an enlarged cross-sectional view of the pipette tip of FIG. 4 fully seated into the pipette of FIG. 1, as modified according to FIG. 3;

FIG. 13 is an enlarged cross-sectional view of the pipette tip of FIG. 4 in the position illustrated in FIG. 11;

FIG. 14 is an enlarged cross-sectional view of the pipette tip of FIG. 4 inserted into the pipette of FIG. 1 in the position illustrated in FIG. 12;

FIG. 15 is a perspective view of a modification of the pipette of FIGS. 4-8;

FIG. 16 is another perspective view of the sealing pipette of FIG. 15;

FIG. 17 is a cross-sectional view of the sealing pipette tip of FIG. 15;

FIG. 18 is an enlarged cross-sectional view of a portion of the view of FIG. 17;

FIG. 19 is an enlarged cross-sectional view of a portion of the view of FIG. 18;

FIG. 20 is an enlarged cross-sectional view of the sealing pipette tip of FIG. 15 inserted into the pipette of FIG. 1, prior to being fully seated therein;

FIG. 21 is another enlarged cross-sectional view of a portion of the pipette tip of FIG. 15 inserted into the pipette of FIG. 1, fully seated therein;

FIG. 22 is an enlarged cross-sectional view of the pipette tip of FIG. 15 inserted to the pipette of FIG. 1, as modified in accordance with FIG. 3, prior to being fully seated therein;

FIG. 23 is another enlarged cross-sectional view of the pipette tip of FIG. 15 inserted into the pipette of FIG. 1, modified in accordance with FIG. 3, and fully seated therein;

FIG. 24 is a further enlarged view of a portion of the pipette tip of FIG. 15 in the positon of FIG. 20;

FIG. 25 is a further enlarged cross-sectional view of the pipette tip of FIG. 15 in the position of FIG. 21.

### DETAILED DESCRIPTION OF THE PREFERRED EMBODIMENT

The inventions disclosed herein are described in the context of pipettes and sealing pipette tips because they have particular utility in this context. However, the inventions disclosed herein can be used in other contexts as well. As is apparent from the description of the inventions set forth below, a system incorporating any of the inventions disclosed can be embodied in a wide variety of forms.

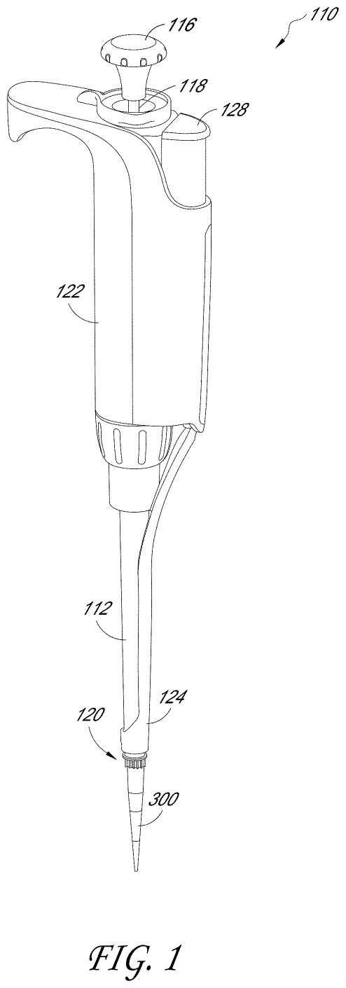

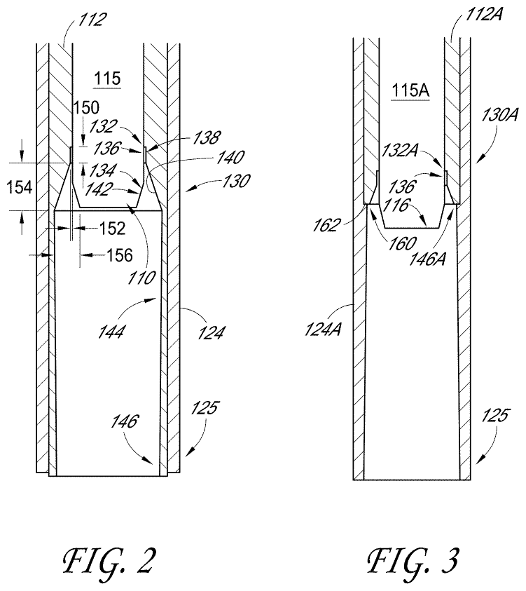

Referring initially to FIG. 1, a handheld pipette 110 according to an embodiment is shown. As with traditional pipettes, the illustrated pipette 110 has a tip-mounting shaft 112, and a sealing tip 300 according to an embodiment, is shown mounted on the shaft 112, with only the liquid handling portion of the pipette tip 300 being visible in FIG. 1. Embodiments of the mounting portion of the pipette tip 300 are described in detail below in detail with reference to FIGS. 2-25.

The overall form factor of the pipette 110 and the sealing tip 300 can be comparable to that of traditional pipettes, and the combination can be used in the same ways and using some of the same techniques as would be performed using traditional pipettes, except as specifically noted below.

The pipette 110 can have a plunger button 116 connected to a plunger rod 118. The button 116 and rod 118 can be spring-biased to a fully-extended position. The plunger rod 118 is coupled to a piston 115 within the pipette 110 (FIG. 2). As with traditional pipettes, when the plunger button 116 is depressed, it moves the plunger rod 118 and the piston 115 downward through the shaft 112 toward a distal end 120 of the shaft 112, from its uppermost position against an upper stop.

As in traditional manual pipettes, the plunger button 116 is spring-biased relative to two positions, namely a released and extended position and a home position. There is a fully-depressed blowout position when the plunger button 116 is depressed past the home position. With no pressure applied to the plunger button 116, a plunger spring biases the plunger button 116 upward against an upper volume-setting stop, the position of which is adjusted by turning the plunger button 116 and a stop position adjustment mechanism as discussed above. In this position, the plunger rod 118 and plunger button 116 are at the released and extended position with respect to the body 122 of the pipette 110.

At the home position, with the plunger button 116 partially depressed, the resistance to depression of the plunger button increases. As is common in handheld pipette construction, a secondary blowout spring adds to the resistance offered by the plunger spring. The increased resistance is sensed by the pipette user and defines the home position. Between the released and extended position and the home position, only the plunger spring biases the plunger button position upward toward its extended position, and a relatively light first force level is required to act against the spring bias.

The plunger button 116 is released from the home position to the fully extended position to aspirate a desired volume of liquid, and subsequently moved from the extended position to the home position to dispense the liquid.

Between the home position and a fully-depressed blowout position, both the plunger spring and the blowout spring act upward against the plunger button 116, and a higher second force level is required to act against the spring bias. This configuration including a primary plunger spring and a secondary blowout spring is common in handheld pipettes. After dispensing, the plunger button 116 is moved from the home position through to the end of the blowout position to eject any remaining liquid from the pipette tip 300.

Accordingly, at the home position, the user feels a tactile transition between the two spring forces, and by exerting a force between the first level and the higher second level, the user can easily keep the plunger button 116 at the home position.

In a traditional handheld pipette, the plunger button acts directly through the plunger rod to a piston, which maintains an air-tight seal with the liquid end of the pipette via a seal within the pipette. The seal remains in a fixed position with respect to the liquid end and further forms an air-tight seal with respect to an interior portion of the liquid end. Accordingly, as the plunger button is manipulated, the piston is moved through the seal and displaces an air volume within the liquid end. With an orifice provided at a distal end of the pipette tip, and a substantially air-tight seal maintained at all other places, the only path for a liquid (or any fluid) to enter or exit the tip is via the orifice, and there is a deterministic relationship between the volume of air displaced by the piston and the volume of liquid manipulated by the pipette.

In accordance with some embodiments, the seal that would normally be disposed in the pipette itself can be eliminated. Thus, in the various disclosed embodiments below, the pipette tip 300 includes a sealing region in the form of a reduced-thickness lip extending from the proximal end of the pipette tip 300 and the piston 115 moves axial within the tip and in sealing engagement with the reduced thickness lip. Accordingly, an air-tight seal is formed at the reduced-thickness lip with the piston 115 and air volume only within the tip 300 is displaced to move liquid in and out of the tip 300. Because there is a direct sealing interaction between the piston 115 and the pipette tip 300, there is no need for an additional seal inside the pipette 110. Thus, in some embodiments, the pipette 110 does not include an internal seal, for example, between the piston 115 and the shaft 112.

In many regards, the pipette 110 can be configured similarly to a traditional handheld manual or electronic pipette. The same volume setting mechanisms, springs, drive mechanisms, plunger mechanisms, and body parts can be employed. The primary differences between a traditional pipette an the embodiment of pipette 110 as described herein can include the following: a) the shaft on the liquid end of the pipette can be adapted to accommodate a tip according to the embodiments described below; 2) a seal (or any other related structure) is not necessary between the air displacement piston of the pipette and any portion of the pipette 110; 3) the piston 115 can be longer and otherwise adjusted in diameter and travel so that the piston 115 forms a seal with an inner surface of the pipette tip 300 and moves within a space in the tip 300, as described below; 4) and the tip ejector 124 can be reconfigured to fit a different shaft 112 and pipette tip 300.

One exemplary general pipette configuration that can be employed and reconfigured as set forth herein is described in U.S. Pat. No. 5,700,959 to Homberg, which is hereby incorporated by reference as though set forth in full.

With continued reference to FIGS. 1 and 2, the pipette tip 300 can be secured to the distal end of the pipette 110. In the illustrated embodiment of the pipette 110, the shaft 112 includes a pipette tip mounting portion 130 to which a proximal end of the pipette tip 300 is attached. The mounting portion 130 can include a space defined between the inner surface of the shaft 112 and an outer surface of the piston 115 which cooperate to securely mount the pipette tip 300 in a fixed position relative to the pipette shaft 112, during operation. The piston 115, which is connected to the plunger rod 118, can move inward and outward relative to the interior of the pipette tip 300 while maintaining an air-tight seal against an inner surface of the pipette tip 300, described in greater detail below.

The mounting portion 130 of the pipette 110 can include various configurations. For example, FIG. 2 is an enlarged cross-sectional view of the mounting portion 130 of the pipette 110 disposed generally at a distal end of the shaft 112. The mounting portion 130 can comprise an annular channel 132 and an enlarged passage 134 disposed distally from the annular channel 132. The annular channel 132 can be defined between an outer surface 136 of the piston 115 and an inner surface 138 of the shaft 112.

The enlarged portion 134 can be defined between a distal portion of the outer surface 136 of the piston 115 and an expanded portion 140 of the inner surface of the shaft 112. The expanded portion 140 of the shaft 112 can be disposed distally from the inner surface 138.

In some embodiments, the outer surface 136 and inner surface 138 are generally or substantially parallel to one another, defining a straight or substantially straight-sided annular channel 132. The expanded portion 134 has a generally expanded cross-sectional area, in the distal direction, which can be provided by a lower portion outer surface 142 of the piston 115 and/or the inner surface 140 extending away from each other, in the distal direction. As such, the surfaces 140, 142 can be nonparallel and generally define a trough-shaped annular channel.

In the illustrated embodiment of the mounting portion 130, the shaft 112 includes a skirt portion 144 extending downwardly from the expanded portion 134, and in some embodiments, includes a distal end 146 terminating at or near a distal end 125 of the ejector 124.

With continued reference to FIG. 2, the channel 132 can have a depth 150, which can be in some embodiments, can be about 2 mm deep and a width 152 which in some embodiments can be 0.5 mm or less. Other dimensions can also be used. The inner surface 140 can have a depth 154 and a width that starts, at its proximal end, at the width 152 and, at its distal end, defines a width 156, relative to the outer surface 136 of the piston 115. The inner surface 140, in the illustrated embodiment, is tapered. However, other configurations can also be used.

With continued reference to FIG. 2, the pipette tip 300, in use, would be inserted through the distal end 146 of the shaft 112, until a proximal end of the tip 300 engages the mounting portion 130, described in greater detail below.

FIG. 3 illustrates an enlarged cross-sectional view of a modification of the mounting portion 130, identified generally by the reference numeral 130A. Parts, components, features, and functions of corresponding parts, components, features, and functions of the mounting portion 130 are identified with the same reference numeral except that a letter “A” has been added thereto.

As shown in FIG. 3, the distal end 146A of the shaft 112A terminates a short distance from the distal end of the channel 132A. In some embodiments, the distal end 146A defines a shoulder 160. Similarly, the ejector 124A can include a corresponding shoulder 162 which engages with the shoulder 160 so as to define a stop. For example, for movement of the ejector 124A in the upward position of the ejector 124A.

In the description set forth below, embodiments of the pipette tip 300, 400 are usable with both the mounting portions 130 and 130A, described above.

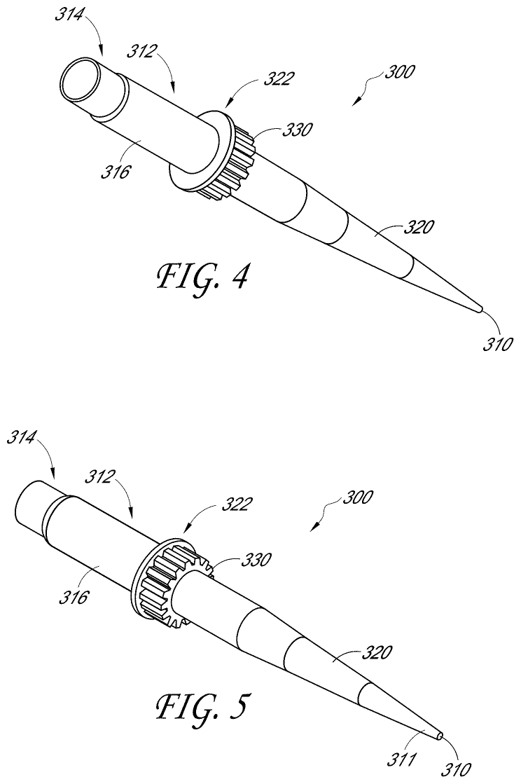

With reference to FIGS. 4 and 5, the pipette tip 300 includes a mount portion 312 and a liquid handling portion 320. In the illustrated embodiment of the pipette tip 300 is sized to accommodate a liquid volume of approximately 10 μl in this configuration. However, the pipette tip 300 can be sized to accommodate a large range of liquid volumes, such as, for example, but without limitation, 1 μl, 2 μl, 5 μl, 10 μl, 20 μl, 50 μl, 100 μl, 200 μl, 300 μl, 500 μl, 1000 μl, 2000 μl, or other sizes.

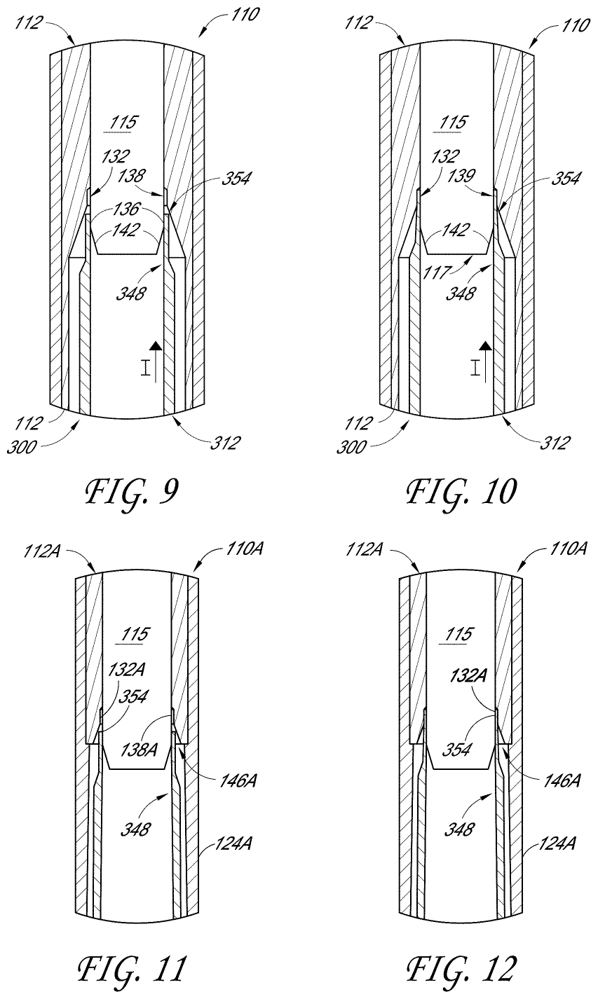

In use, the mounting portion 312 extends into the mount portion 130 of the pipette (FIGS. 2-3), is secured to the inner surface of the shaft 112, and also achieves an air tight seal with the outer surface of the piston 115, as described in greater detail below with reference to FIGS. 9-14.

The mount portion 312 includes a reduced-thickness lip 314. The reduced-thickness lip 314, in some embodiments, is configured to provide the dual functions of achieving a secure mount to the pipette shaft 112, as well as forming an air-tight seal with the piston 115. The mount portion 312 also includes a base portion 316 which provides an internal volume in which the piston 115 can extend into and retract from during use of the pipette 110, described in greater detail below.

Between the mount portion 312 and the liquid handling portion 320 of the pipette tip 300, a peripheral shelf 322 extends radially outwardly from the pipette tip 300. The peripheral shelf 322 can serve as a stop for the distal end 125 of the ejector 125 and/or the distal end 146 of the shaft 112, in some embodiments. The shelf 322 can provide a surface for the ejector 124 to act against during ejection of the pipette tip 300. Additionally, the shelf 322 can be useful to stabilize the pipette tip 300 against lateral forces exerted during use of the liquid handling portion 320 of the pipette tip 300.

In some embodiments, the peripheral shelf 322 can act in cooperation with the reduced-thickness lip 314 during insertion and for stabilization purposes. In some embodiments, the shelf 322 is not used for limiting the depth of insertion of the pipette tip 300 into the pipette 110; a step defined by a portion of the mounting portion 130 can serve that purpose. In some embodiments, when the pipette tip 300 is mounted to the pipette 110 with the reduced-thickness sealing lip 314 secured to the mounting portion 130 of the pipette 110, the shelf 322 can be close to, but not in contact with the distal end 146 of the shaft 112 or the distal end 125 of the ejector 124.

With continued reference to FIGS. 4 and 5, the pipette 300 includes an orifice 310 at the distal end 311 of the pipette 300. A plurality of radial fins 330 can be arranged around an exterior of the pipette tip 300; the fins 330 can be configured to provide a relatively wide surface to rest against an upper surface in a pipette rack, stiffen the pipette tip 300 against lateral bending, and further provide texture for ease and gripping and maneuvering pipette tips by hand. The fins 330 can also be arranged to provide an aesthetically pleasing configuration and/or provide a basis for trade dress of the pipette tip 300. In the illustrated embodiment, the fins 330 are disposed below the shelf 322, although other configurations can also be used.

With reference to FIGS. 4-6, the pipette tip 300 can be monolithically formed of only a single piece of material or formed in multiple parts connected together. For example, the distal liquid handling segment 320 can be connected to the mount portion 312 with an interference fit. In some embodiments, the fit can be achieved without adhesive and form an air-tight seal therebetween. Additionally, in some embodiments, a membrane filter (not shown) can be disposed between the liquid handling segment 320 and the mount portion 312. Alternatively, in some embodiments, the mount portion and the liquid handling segment 320 can be molded into a single piece so as to form a monolithic structure.

The membrane filter can be a polymer, such as expanded PTFE or a woven or fibrous material. Such material is generally hydrophobic, but permits relatively free passage of dry air. Using such a material as a pipette tip filter can effectively prevent liquids from reaching the pipette shaft and piston, even when in the form of very small droplets. The membrane filter is an optional component of a sealing tip 310, and if protection of the pipette's piston is not necessary or advantageous, it may be omitted. Alternative forms of filters, such as porous plastic plugs, may also be employed in an embodiment of the pipette tip 300.

The disclosed sealing pipette tip 300, being assembled from separate components, can employ different materials for the mount segment 312 and the liquid handling segment 320.

Traditional pipette tips are generally molded from virgin polypropylene, without a substantial quantity of additives (although some pipette tips may include small quantities of coloring agents or hydrophobicity enhancers). The sealing pipette tip 300 can also be assembled from components of injection-molded polypropylene, but certain optional advantages can be realized by altering the composition of either the mount segment 312, the liquid handling segment 320, or both.

For example, the mount segment 312 can be molded from either polypropylene or another polymer, impregnated with a desired proportion of a lubricity-enhancing agent like PTFE (polytetrafluoroethylene, commonly known as DuPont TEFLON™). The composition of the mount segment 312 can thus be adjusted to provide a firm mount to the pipette shaft 112 (FIG. 1) while maintaining smooth and leak-free seal to the piston (as described below with reference to FIGS. 11-13). Alternatively, a thermoplastic elastomer that is softer than polypropylene or polyethylene may be used for the mount segment 312, thereby reducing the force required to mount or eject the sealing tip 300 from the pipette 110, reduce drag on the piston, and optionally affect the manner in which the reduced thickness lip 314 deforms during insertion.

Moreover, the use of two separate segments in the tip 300 permits various additives to be used in the mount segment 312, which may or may not be chemical resistant, without compromising the performance of the sealing tip 300 or the purity of any liquids contacted by the liquid handling segment 320. Accordingly, the mount segment 312 can be colored more aggressively, or made of various physically desirable materials, that would otherwise be considered unacceptable in a traditional pipette tip.

Similarly, the liquid handling segment 320 can contain a low-retention additive or coating, to discourage adhesion of certain liquids to the tip, without adversely impacting the mount between the sealing tip 300 and the pipette.

Although the tip 300 is described above as being assembled from separate molded components, it should be recognized that a tip using multiple materials (but generally without a membrane filter) may be manufactured using an overmolding technique. Under some circumstances it may be more advantageous or cost-effective to do so.

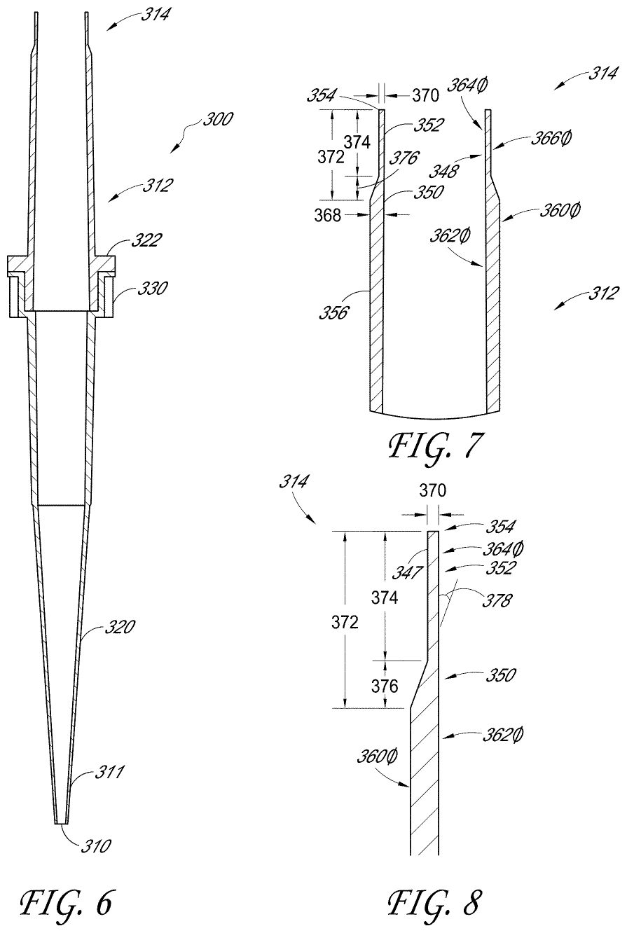

FIG. 6 shows the sealing pipette tip 300 in assembled form. As shown in FIG. 6, a relatively tight friction fit between an interior surface of the liquid handling segment 320 and an exterior surface of the mount segment 312 can be sufficient to hold the parts together in an air-tight assembly, and to maintain a desired position of a membrane filter between the mount segment 312 and the liquid handling segment 320. As disclosed, the membrane filter can be sized slightly larger than the outer diameter of a cylindrical end of the mount segment 312, and when the parts are pressed together, the membrane filter bends around the flat cylindrical end of the mount segment 312 and is held securely in place within the liquid handling segment 320.

The optional membrane seal can be provide to separate the mount segment 312 from the liquid handling segment 320, allowing air to pass relatively freely between the two segments while impeding the flow of liquids, aerosol droplets, and particulates. The junction between the liquid handling segment 320 and the mount segment 312 is air-tight and fluid-tight, and as shown in FIG. 6 depends on an interference fit to maintain the fit and seal between the two segments. Other connection means, such as a ring-and-groove joint, can also be employed to similar effect. The membrane seal can also be welded to either the mount segment 312 or the liquid handling segment 320 prior to the two segments being joined, or all components may be welded, bonded, or otherwise affixed together using an adhesive. The inclusion of a membrane filter and membrane seal in said embodiments disclosed herein is further explained in U.S. patent application Ser. No. 15/170,262, the entire contents of which is hereby expressly incorporated by reference.

With continued reference to FIGS. 7 and 8, the reduced-thickness lip 314 of the mount portion 312 is configured to, in some embodiments, perform the dual functions of generating a secure mounting engagement with the shaft 112, as well as generating an air-tight seal with the piston 115.

In some embodiments, the reduced thickness portion 352 of the reduced-thickness lip 314 can have a significantly reduced stiffness relative to the stiffness of the side wall 356. As such, the reduced thickness portion 352 can deform to a greater extent than that of the side wall 356 and thereby better deform into conformity with an inner surface of the shaft 112 and an outer surface of the piston 115, described in greater detail below with reference to FIGS. 10-13.

With reference to FIG. 8, the reduced thickness lip 314 can include a distal transition portion 350 and a proximal reduced-thickness lip portion 352 terminating at a proximal end 354. In some embodiments, the proximal portion end 354 can have generally the same thickness and extend generally linearly from the transition portion 350, e.g., have a substantially uniform diameter along the portion between the transition portion 350 to the proximal end 354. The transition portion 350 can provide a stepped or smooth transition from the thickness of the proximal portion 352 and the side wall 356 of the mounting portion 312.

With continued reference to FIGS. 7 and 8, the mounting portion 312 can include a distal outer diameter 360, a distal portion inner diameter 362, a proximal portion inner diameter 364, and a proximal portion outer diameter 366 which is smaller than the outer diameter 360.

The side wall of the mounting portion 314 can have a thickness 368 and a proximal portion thickness 370. The total length of the reduced-thickness lip 314 can be considered a length 372 including a transition portion 350, the proximal portion 352 of the reduced-thickness lip 314 and the proximal end 354. The transition portion 350 can be considered as having a length 376. The proximal portion 352, extending from the transition portion 350 to the end 354, can have a length 374.

In some embodiments, the thickness 370 is less than one-half of the thickness 368. Additionally, the length 374 can be at least five times the value of the thickness 370. As such, it has been found that the reduced-thickness lip 314 can be configured with sufficient length and flexibility to conform and thus provide secure mounting to a shaft 112 of the pipette as well as an air-tight seal against an outer surface of the piston 115, during use. In some embodiments, the thickness 370 of the reduced-thickness lip 314 can be configured to provide sufficient flexibility to allow the reduced-thickness lip 314 to buckle upon insertion into the pipette 110, to thereby provide sealing to the piston 115 in a preferred location, further ensuring reliable and repeatable operation.

Optional, non-limiting embodiments of the mount portion 312 can have the following optional dimensions, for example, in embodiments of the pipette tip sized for 10 μl and 200 [symbol] :

| | 10 [symbol] tip | 200 [symbol] tip |
|---|---|---|
| Outer diameter 360: | 1.3-3.0 mm | 4.4-7.0 mm |
| Inner diameter 362: | 0.9-2.0 mm | 4.0-6.0 mm |
| Inner diameter 364: | 0.9-1.5 mm | 4.0-5.0 mm |
| Outer diameter 366: | 1.0-1.9 mm | 4.1-5.4 mm |
| Wall thickness 368: | 0.2-0.5 mm | 0.2-0.5 mm |
| Wall thickness 370: | <0.2 mm | <0.2 mm |
| Length 372: | 3-15 mm | 3-15 mm |
| Length 374: | 2-10 mm | 2-10 mm |
| Length 376: | 1-5 mm | 1-5 mm |
| Angle 378: | <45° | <45° |

The above-identified dimensions of the reduced-thickness lip 314 are not required for all embodiments of the inventions disclosed herein. However, in some embodiments, as noted above, the thickness 370 can be less than one-half of the wall thickness 368. Additionally, in some embodiments, the length 374 can be more than five times the value of the thickness 370. Thus, the pipette can have sufficient overall structural strength to withstand forces typically applied to pipette tips during laboratory use and the proximal portion 352 of the reduced-thickness lip 314 can have sufficient length and flexibility to achieve both a reliable mounting engagement to the inner surface of the shaft 112 as well as conforming for an air-tight seal against an outer surface of the piston 115, without the need for the pipette 110 having an internal seal. In some embodiments, the thickness 370 is between 0.09 mm and 0.5 mm, 0.1 mm and 0.4 mm, 0.1 mm and 0.3 mm, 0.1 mm and 0.2 mm, or can be expressed as less than 0.5 mm, less than 0.4 mm, less than 0.3 mm, or less than 0.2 mm. Other dimensions can also be used.

For example, with reference to FIGS. 9 and 10, attachment of the pipette tip 300 to the pipette 110 would begin with a user inserting the mounting portion 312 of the pipette tip through the distal end 146 of the shaft 112. As the proximal end 354 reaches the distal end of the piston 115, the proximal end 354 would be guided over the distal end of the piston 115 by the tapered surface 142 of the piston 115.

As the mounting portion 312 is pushed further into the shaft 112, the inner surface 348 of the mounting portion 312, in the vicinity of the proximal end 354 comes into contact with the cylindrical outer surface 136 of the piston 115. In this position, as illustrated in FIG. 10, with the inner surface 348 of the mounting portion 312 in contact with the cylindrical outer surface 136 of the piston 115, and further with the alignment provided by the remaining portion of the mounting portion 312 extending through the distal portion 146 of the shaft 112, the pipette tip 300 would be in proper alignment for further insertion and securement to the shaft 112.

For example, FIG. 10 illustrates the mounting portion 312 of the pipette tip 300 having been further pushed into the pipette 110, by movement along the direction I. More specifically, the proximal end 354 of the pipette tip has been pushed upwardly, in the direction of arrow I, until it reaches an end 139 of the annular channel 132 defined in the shaft 112.

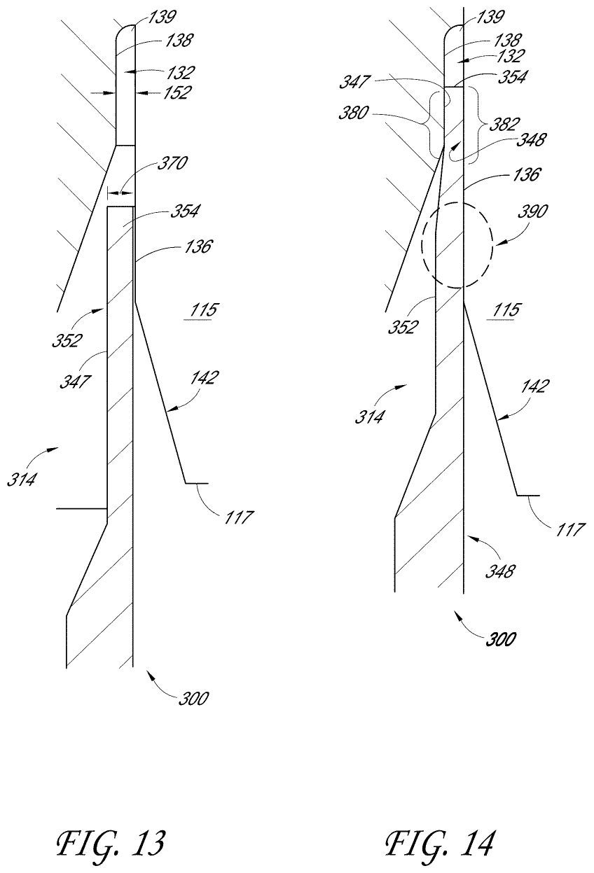

The movement illustrated in FIGS. 9 and 10 is shown in a further enlarged cross sections in FIGS. 13 and 14. In some embodiments, the width 152 of the annular channel 132 can be slightly smaller than the width 370 of the proximal end 354 of the reduced-thickness lip. For example, the width 152 can be 0.02 mm smaller than the width 370. Other dimensions can also be used.

By forming the annular channel 132 with a width 152 that is smaller than the width 370 at the proximal end 354 of the reduced-thickness lip 314, the proximal end 354 can become more strongly wedged between the outer surface 136 of the piston 115 and the outer wall surface 138 of the channel 132, as shown in FIG. 14. This configuration can also help to generate contact between the shaft 112, pipette tip 300 and piston 115 in desired and repeatable positions, thereby helping to maintain accurate and precision operation.

In other embodiments, the width 152 is the same size or larger than the thickness 370. Further, optionally, the inner diameter of the outer wall surface 138 of the channel 132 can be the same as or less than the outer diameter 366 of the outer surface 347 of the reduced thickness lip 314. For example, in some embodiments, the inner diameter of the wall surface 138 can be 0.001 mm (or a greater amount) less than the outer diameter 366 of the outer surface 347. As such, during insertion into the pipette 110, the reduced thickness lip 314 can be deformed inwardly, causing contact with the inner surface 138 of the channel 132 and into sealing contact with the outer surface of the piston 115. This configuration can also help to generate contact between the shaft 112, pipette tip 300 and piston 115 in desired and repeatable positions, thereby helping to maintain accurate and precision operation.

In some typical uses of the pipette 110 with the pipette tip 300, the user may grasp the pipette 110 and gently tap the pipette 110 and pipette tip 300 (as initially attached in the position of FIG. 10), onto a pipette tip holder (not shown), in order to fully seat the pipette tip 300 into the pipette 110. In some cases, a user may exert a force as high as approximately 20 pounds during such tapping. On the other hand, a user might use as little as one or two pounds of force for seating the pipette tip 300 into the pipette 110. Thus, the difference in the width 152 of the channel 132 and the width 370 of the proximal end 354 of the reduced-thickness lip 314 or the difference between the outer diameter 366 and the inner diameter of the outer wall surface 138 of the channel 132 can be sized such that the pipette tip 300 is appropriately seated in contact with the shaft 112 and the piston 115 over at least a portion or the entirety of such a range of insertion forces.

With continued reference to FIG. 14, when the pipette tip 300 is inserted into the pipette 110, the outer surface 347 of the proximal portion 352 creates a contact patch 380 with the inner surface of the channel 132 defined by the shaft 112. Similarly, the inner surface 348 of the proximal portion 352 of the reduced-thickness lip 314 creates a contact patch 382 with the outer surface 136 of the piston 115, which can be approximately the same height as the contact patch 380. However, because the contact patch 380 exists along a surface that has a larger diameter than the surface along which the contact patch 382 extends, the total size of the contact patch 380 is larger than the contact patch 382. As such, total friction between the reduced-thickness lip 312 and the shaft 112 can be larger than the total friction between the piston 115 and the proximal portion 352. In other words, the total static friction generated by the contact patch 380 can be larger than the maximum total friction generated at the contact patch 382 by movement of the piston 115. Even if the coefficients of friction existing between the inner surface 138 and the surface 347 is the same as the coefficient of friction existing between the inner surface 348 and the outer surface 136 of the piston. In some embodiments, the outer surface 136 of the piston is polished to a lower surface roughness than the inner surface 138.

In the illustrated embodiments, the outer surface 347 does not include any structural protrusions, beyond the inherent surface features, known as asperities, that exists and, in part, define the surface roughness of the surface 347. For example, the outer surface 347 does not include any structural protrusions such as beads, ridges, ramps faces, or the like, protruding from the part of the surface 347 that forms the contact patch 380, and that could be used for achieving an snap fit, snap lock, or other type of interference fit or other engaging technique that relies on protrusions for engagement. Rather, in such embodiments, the outer surface 347 remains fixed to the inner surface of the channel 132 by way of static frictional forces generated by surface interactions without protrusions.

As such, the contact patch 380 can secure the pipette tip 300 to the shaft 112 while allowing the piston 115 to slide relative to the mounted pipette tip 300 during use. Additionally, different materials and/or surface roughnesses on the shaft 112, piston 115, outer surface 347, and inner surface 348 can be used to make the total static friction existing at the contact patch 380 larger than the maximum friction generated at the contact patch 382 during movement of the piston 115.

For example, the materials and/or surface roughness of the inner surface of the channel 132 and the outer surface 347 of the proximal portion 352 can each define a surface characteristic that together generate a static coefficient of friction at the contact patch 380. Similarly, the materials and/or surface roughness of the outer surface 136 of the piston 115 and the inner surface 348 of the proximal portion 352 can each define a surface characteristic that together generate a second maximum coefficient of friction (which may be higher than the static coefficient of friction, generated at low speed relative sliding between the surfaces 136 and 347) at the contact patch 382 that is lower than the first static coefficient of friction. In embodiments where the first static coefficient of friction is larger than the second maximum coefficient of friction, the pipette tip 300 can remain secured in position against the inner surface of the shaft while the piston 115 slides within the pipette tip 300, even if the contact patch 380 is the same size or smaller than the contact patch 382.

As used herein, the term “friction” is intended to refer to the force resisting the relative motion of solid surfaces, fluid layers, and material elements sliding against each other. There are several types of friction. “Dry friction” is a force that opposes the relative lateral motion of two solid surfaces in contact. Dry friction is subdivided into static friction (“stiction”) between non-moving surfaces, and kinetic friction between moving surfaces. With the exception of atomic or molecular friction, dry friction generally arises from the interaction of surface features, known as asperities. It has long been believed that static friction, and thus the static coefficient of friction between to surfaces, is the largest frictional force that can be generated between two surfaces, kinetic frictional forces being smaller. However, in some cases, depending on the surface characteristics, there may be a third friction force magnitude that is higher than both the static frictional forces and the observed kinetic frictional forces generated by two sliding surfaces, when the two surfaces are moving at very low relative speeds. This higher frictional force is referred to herein as a “maximum” frictional force generated by a “maximum” coefficient of friction.

In some embodiments, the insertion of the proximal end 354 of the reduced-thickness lip 314 into the channel 132 can cause the proximal portion 352 to buckle, a known deformation mechanism of a columnar structure. In this context, the reduced-thickness lip 314 can be considered to be in the form of a thin-walled column. Under the insertion force used to insert the pipette tip 300 into the pipette 110, a buckling threshold of the reduced-thickness lip 314 can be overcome, thereby causing the portion of the proximal portion 352 below the channel 132 (as viewed in FIG. 14) to bulge outwardly, in the vicinity of the area identified generally by the reference 390. Such a buckling deformation can help ensure that the contact patch 382 between the outer surface of the piston 115 and the inner surface 348 of the reduced-thickness lip remains approximately within the channel 132.

In some embodiments, the inner diameter 364 of the reduced-thickness lip 314 can be slightly larger than the outer diameter of the outer surface 136 of the piston 115. In such an embodiment, where the width 152 of the channel 132 is smaller than the width 370 of the proximal end 354 of the reduced-thickness lip, or where the inner diameter of the inner surface 138 is smaller than the outer diameter 366, the outer wall surface 138 of the channel 132 defined by the shaft 112 would press the inner surface 348 of the reduced-thickness lip 314 toward and into contact with the outer surface 136 of the piston 115. Below the channel 132 (as viewed in FIG. 14), the inner surface 348 of the reduced thickness lip can be spaced away from the outer surface 136 of the piston 115, thereby helping to maintain the contact patch 382 between the reduced thickness lip 314 and the outer surface 136 of the piston 115 in an area approximately within the channel 132.

As described above, the outer surface 347 of the proximal portion 352 in contact with the inner surface 138 of the channel 132, the pipette tip 300 remains securely mounted to the shaft 112, even as the piston 115 slides longitudinally within the pipette tip 300, contacting and sealing against the piston 115 in an air-tight manner. In this context, “securely mounted” can mean that a pipette tip 300 can remain attached to the pipette 110, under the full weight of the pipette tip 300, while completely filled with contents, for example, filled to its maximum capacity with a liquid, regardless of that liquid's density (e.g., water has a density of 1 g/ml and mercury has a density of 13.6 g/ml). Further, a completely filled pipette tip 300 should remain attached to the pipette 110, in a fixed position, even if the pipette is moved by the user, thereby subjecting the filled pipette tip 300 to additional forces.

In use, with the pipette 110 set to its maximum volume setting, when the piston 115 is in the released and extended position (and little or no pressure is exerted on the plunger button 116), a distal face 116 of the piston 115 only slightly penetrates the mounting portion 312 of the pipette tip 300, a distance sufficient for the piston 115 to engage the inner surface 348 of the reduced thickness lip 314 and form an air-tight seal, and preferably a little further. As the plunger button 116 is depressed, the piston 115 moves into the mounting portion 312, displacing air within the pipette tip 300. At the lowest point of the plunger button 116 corresponding to a completely blowout stroke, the distal face 116 of the piston 115 may be almost directly adjacent the distal end of the mounting portion 312, and in embodiments where there is a membrane filter, almost adjacent to the membrane filter. Accordingly, the size of the space within the mounting portion 312 of the pipette tip 300 can be at least the maximum liquid volume of the pipette tip 300 plus enough additional volume for the blowout stroke, and is preferably minimally larger than that.

This minimization of air volume tends to improve pipetting performance. Better accuracy and precision can be maintained in low volume ranges (particularly in the 2 μl and 10 μl pipettes, and similar volume ranges with their corresponding tips). The blowout stroke tends to be more effective (as blowout displaces more of the total air volume than is possible using a traditional pipette configuration). Accuracy and precision can be improved even in larger volume pipettes when used in the lower portion of their adjustable volume ranges.

The illustrated embodiment of the pipette tip 300, illustrated in FIGS. 4, 5, and 6, is assembled from several parts. An alternative form can be manufactured as a single part, by injection molding or another suitable technique. Where the pipette tip 300 itself is fabricated in this manner, a traditional porous plastic filter can be inserted, as in commercially available traditional pipette tips.

FIGS. 11 and 12 illustrate the insertion of the pipette tip 300 into the pipette 110A, with the modified distal end illustrated in FIG. 4. As noted above with reference to FIG. 4, the distal end 146A of the shaft 112A ends near the distal end of the channel 132A. In this configuration of the pipette 110A, the inner surface of the ejector 124A can be slightly larger than the outer surface of the mounting portion 312 so as to provide some assistance in aligning the proximal end 354 of the reduced-thickness lip 314 with the piston 115 and the channel 132A. Otherwise, the insertion and function of the reduced-thickness lip 314 are the same as those described above with reference to FIGS. 9, 10, 13, and 14.

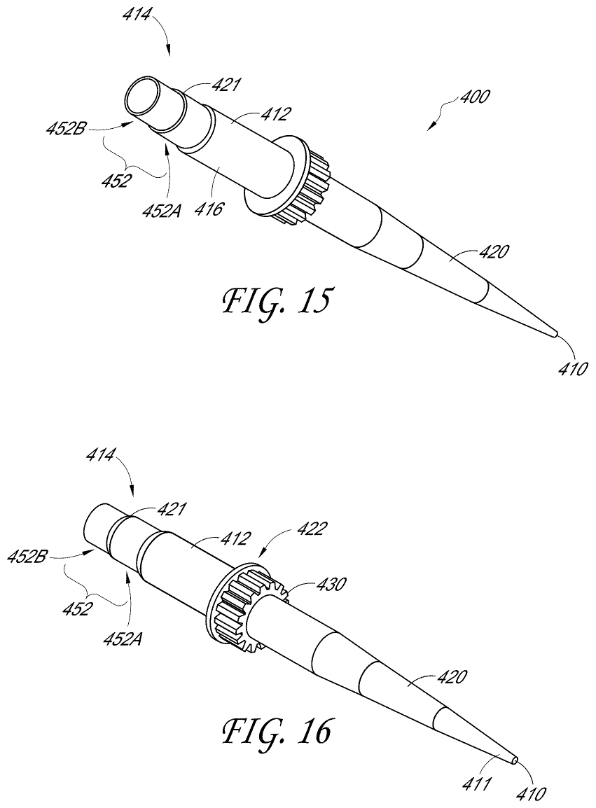

FIGS. 15-19 illustrate a modification of the pipette tip 300, identified generally by the reference numeral 400. Parts, components, features, and advantages of the pipette tip 400 corresponding to the same or similar parts, features, advantages, or functions of the pipette tip 300 are identified with the same reference numeral, except that “100” has been added thereto.

Generally, the liquid handling portion 420, distal end 411, orifice 410, shelf 422, and fins 430 can be constructed in accordance with the descriptions set forth above with reference to the corresponding parts of the pipette tip 300. Further to those features described above, the reduced-thickness sealing lip 414 of the pipette tip 400, can include a stepped configuration, characterized by the intermediate step 421 disposed along the proximal portion 452 of the reduced-thickness lip 414, dividing the proximal portion 452 into a distal sub-portion 452A and a proximal sub-portion 452B.

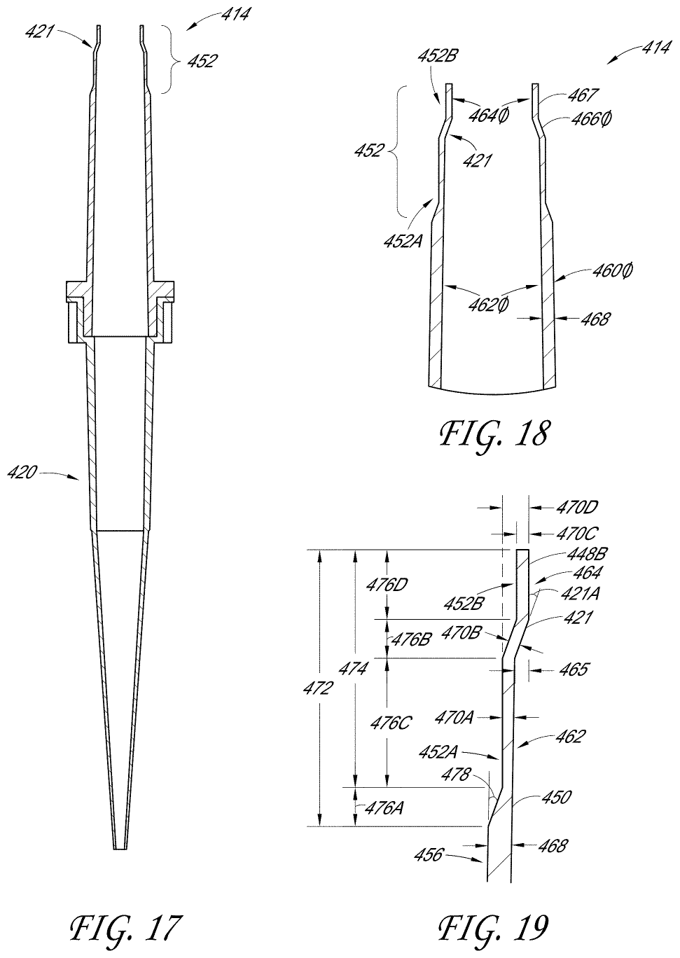

With reference to FIGS. 17-19, in some embodiments, the distal sub-portion 452A can have an inner diameter 462 which can be coincident with the inner diameter of the immediately distal portions of the side wall 456 of the pipette tip 400. In some embodiments there can be differences between an inner diameter of the distal adjacent portions of the side wall 456 and the inner diameter 462 of the distal portion 452A.

The proximal sub-portion 452B can have an inner diameter 464 that is smaller than the inner diameter 462. The portions of the inner surface of the distal and proximal sub-portions 452A, 452B defining the inner diameters 462, 464 can be parallel, or substantially parallel, for example, within about 0.1 to 10 degrees of parallel.

The intermediate step 421 can define a change in inner diameter of the reduced thickness lip 414; from the larger inner diameter 462 to smaller inner diameter 464. The intermediate step 421 can be considered as defining a transition diameter 465, which can be expressed as a difference in diameter of the inner surface of the distal portion 452A and the inner surface of the proximal portion 452B.

The pipette tip 400 can also include a distal transition portion 450, in which the wall thickness of the pipette tip 400 transitions from the larger wall thickness of the side wall 456, to a smaller wall thickness on a distal side of the intermediate step 421. The distal transition portion 450 can have a length 476A and the intermediate step 421 can have a length 476B. The distal and proximal sub-portions 452A, 452B can have lengths 476C and 476D, respectively.

The length 476B of the intermediate step 421 and the diametric difference 465 can be sized so as to result in different angles of orientation of the intermediate step 421. For example, as the length 476B approaches zero, the angle of the intermediate step 421A relative to the distal and proximal sub-portions 452A, 452B would approach 90 degrees. Further as the relative size of the length 476B becomes larger compared to the diametric difference 465, the angular orientation of the intermediate step 421A would approach parallel with the distal and proximal sub-portions 452A, 452B.

In some embodiments, the relative sizes of the length 476B and the diametric difference 465 results in an angular orientation 421A of the intermediate step 421 of an angle between about 1 degree and 90 degrees. In the illustrated embodiment, the angular orientation 421A is approximately 30 degrees. The angular orientation 421A of the intermediate step 421 can be considered as being defined by an angular orientation of the inner surface of the intermediate step 421, and outer surface of the intermediate step 421, or by the orientation of a line extending through the thickness of the intermediate step 421 and parallel or substantially parallel to the inner and outer surfaces of the intermediate step 421.

With continued reference to FIG. 19, the reduced thickness lip 414 can include a distal thickness 470A, an intermediate thickness 470B, and a proximal thickness 470C. Additionally, an overall width 470D can be considered as measured from the outer surface of the distal sub-portion 452A to the inner surface of the proximal sub-portion 452B.

An embodiment of the mount portion 412 can have the following optional dimensions:

| | |
|---|---|
| Angle 421 A: | <45° |
| Outer diameter 460: | 7.4-11.0 mm (tip) |
| Inner diameter 462: | 7.0-9.0 mm (tip) |
| Inner diameter 464: | 7.0-9.0 mm (proximal) |
| Difference 465: | <1.0 mm |
| Outer diameter 466: | 7.1-9.7 mm (middle) |
| Outer diameter 467: | 7.1-9.4 mm |
| Wall thickness 468: | 0.2-1.0 mm |
| Wall thickness 470A: | <0.5 mm (middle) |
| Wall thickness 470B: | <0.5 mm |
| Wall thickness 470C: | <0.2 mm (proximal) |
| Width 470D: | (470A) + (465) |
| Length 472: | 5-25 mm |
| Length 474: | 5-25 mm |
| Length 476A: | 0-10 mm |
| Length 476B: | 1-5 mm |
| Length 476C: | 2-15 mm |
| Length 476D: | 2-10 mm |
| Angle 478: | <45° |

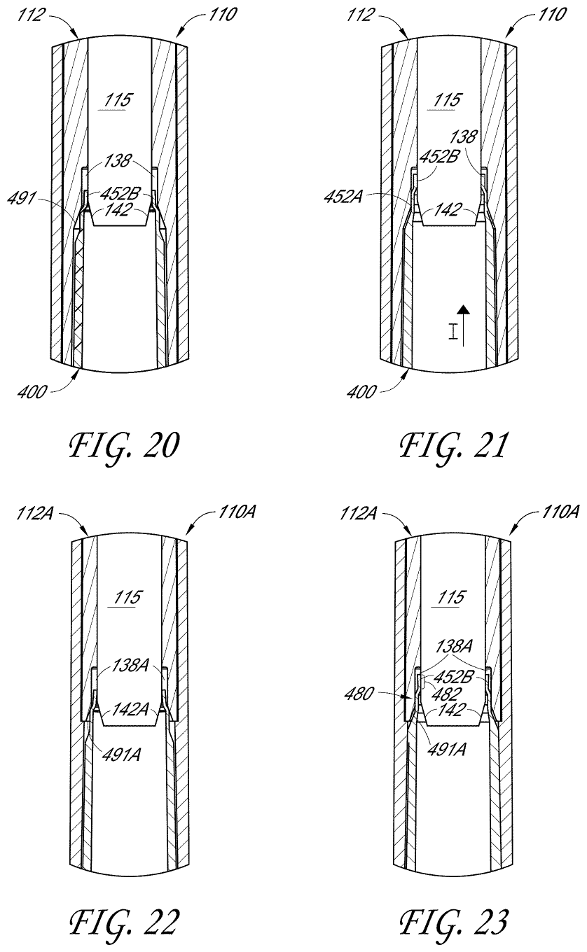

FIGS. 20 and 21 illustrate the movement installation of the pipette tip 400 into a pipette shaft such as that illustrated in FIGS. 9 and 10.

FIG. 20 illustrates an initial position of the pipette tip 400 in which the proximal sub-portion 452B has been pushed upwardly over the tapered surface 142 of the piston 115 and such that the proximal sub-portion 452B extends partially into the channel 132. As shown in FIG. 20, the diameter 466 is slightly larger than the inner diameter of the channel 132. Thus, in the position illustrated in FIG. 20, the intermediate step 421, at its outer surface, contacts the inner surface of the channel 132. Additionally, the inner surface 448B of the proximal portion 452B contacts the outer cylindrical surface 136 of the piston 115.

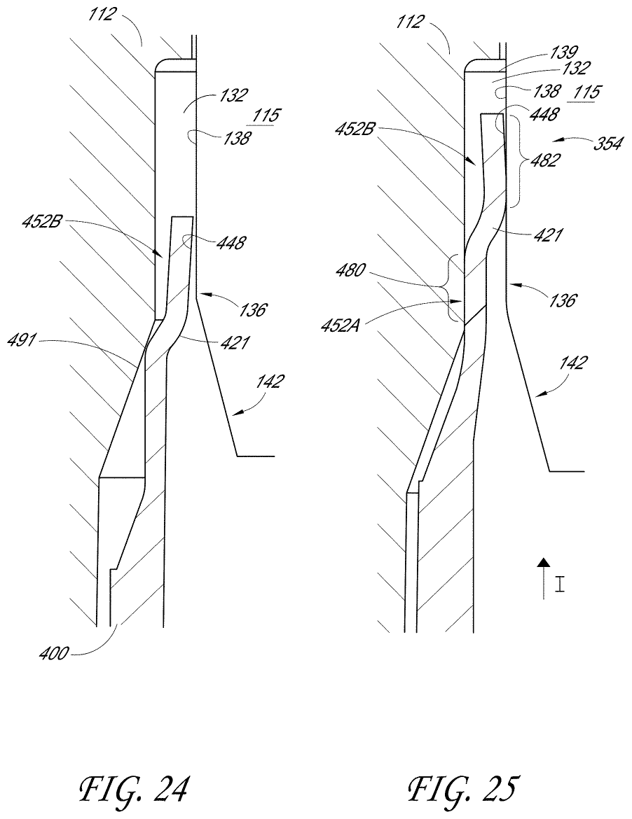

As the pipette tip 400 is moved further upwardly, in the direction of arrow I illustrated in FIG. 21, the outer surface of the intermediate step 421 interacts with the tapered opening 491 of the channel 132 and thereby deflects inwardly, a portion of the distal portion 452A, thereby pressing the proximal portion 452B into further contact with the outer surface 136 of the piston 115. This interaction is shown in greater detail in the enlarged cross-sectional views of FIGS. 24 and 25.

With continued reference to FIGS. 24 and 25, FIG. 24 corresponds to the position illustrated in FIG. 20 and FIG. 25 corresponds to the position illustrated in FIG. 21.

As shown in FIG. 24, when the pipette tip 400 is inserted into the position until the outer surface of the intermediate step 421 contacts the inner surface of the tapered entrance 491 of the channel 132, the proximal sub-portion 452B of the reduced thickness lip 414 extends into the channel 132. In this position, the inner surface 448B of the proximal sub-portion 452B can contact the outer cylindrical surface 136 of the piston 115.

With reference to FIGS. 21 and 25, as the pipette tip 400 is moved further into the pipette shaft 112 in the direction of arrow I, the outer surface of the intermediate step 421 interacts with the inner surface of the channel 132 and is thereby pressed inwardly towards the cylindrical outer surface of the piston 115. As such, the proximal sub-portion 452B is further pressed into contact with the outer surface of the piston 115. However the intermediate step 421, defining a change in the inner diameter of the proximal portion 452, causes the contact patch 482 between the inner surface 448 and the outer surface of the piston 115 to form preferentially between the proximal sub-portion 452B and the outer surface 136 of the piston 115. The inner surface 462 of the distal portion 452A can remain spaced away from the outer surface of the piston 115 due to the differential in diameter 465 between the inner diameter of the distal portion 452A and the inner diameter of the proximal portion 452B. As such, the contact patch between the proximal sub-portion 452B and the outer surface of the piston 115 can be more reliably generated in a desired and repeatable location, helping to provide precise and accurate operation.

With continued reference to FIG. 25, the outer surface of the distal portion 452A forms a contact patch 480 with the inner surface 138 of the channel 132. The friction generated at the contact patch 480 achieves securing of the pipette tip 400 in place during reciprocal movement of the piston 115. Additionally, the knee-shaped configuration of the reduced thickness lip 452 can provide a more predictable location of the contact patch 482 between the reduced thickness lip 452 and the outer surface of the piston 115 during reciprocal movement of the piston 115. Additionally, the intermediate step 421 places the inner surface 448 of the proximal sub-portion 452B, and thus the contact patch 482 at an even smaller diameter than the diameter at which the contact patch 480 lies. Thus, the contact patch 482 can be even smaller than the contact patch 480, affecting the static friction generated at the contact patch 480 and the maximum friction generated at the contact patch 482.

FIGS. 22 and 23 illustrate the insertion of the pipette tip 400 into the variation of the pipette 110A illustrated in FIGS. 11 and 12. As noted above with reference to FIGS. 11 and 12, the pipette shaft 112A illustrated in FIGS. 22 and 23 includes a distal end 146A that terminates a short distance from the distal end of the channel 132A.

It should be noted that although the embodiment of the sealing tip 400 illustrated in FIGS. 15-25 is assembled from several parts, an alternative form may be manufactured as a single part, by injection molding or another suitable technique. Where the tip itself is fabricated in this manner, a traditional porous plastic filter may be inserted, as in commercially available traditional pipette tips.

It should be observed that while the foregoing detailed description of various embodiments of the present invention is set forth in some detail, the invention is not limited to those details and a sealing pipette tip and seal-less pipette made according to the invention can differ from the disclosed embodiments in numerous ways. In particular, it will be appreciated that embodiments of the present invention may be employed in many different fluid-handling applications. It should be noted that functional distinctions are made above for purposes of explanation and clarity; structural distinctions in a system or method according to the invention may not be drawn along the same boundaries. Hence, the appropriate scope hereof is deemed to be in accordance with the claims as set forth below.

What is claimed is:

1. A disposable pipette tip for use with an air displacement pipette having an elongated tip-mounting shaft with an interior surface, a piston having an outer surface and mounted for axial movement within the shaft, and an annular channel defined between the interior surface of the mounting shaft and the outer surface of the piston, the annular channel having substantially parallel walls, the pipette tip comprising:
a liquid handling portion comprising an elongated, tubular liquid handling body with a first distal end and a first proximal end, and an orifice disposed at the first distal end;
a mount portion extending from the first proximal end of the liquid handling portion, the mount portion including a distal portion and a proximal end portion, the distal portion comprising a first wall thickness, the proximal end portion having a uniform cross section portion comprising a second wall thickness smaller than the first wall thickness and being between 0.1 mm and 0.3 mm, the proximal end portion having a length of at least 2 mm, the proximal end portion having a pipette tip outer surface comprising a first material and a first surface roughness defining a first surface characteristic, and wherein the proximal end portion also comprises a pipette tip inner surface, parallel to the pipette tip outer surface, and comprising the first material and a second surface roughness defining a second surface characteristic, wherein there is no structural protrusion on the pipette tip outer surface of the proximal end portion;
wherein the first surface characteristic produces a static coefficient of friction that generates a static frictional force in use when the pipette tip outer surface is in contact with the interior surface of the elongated tip mounting shaft of a pipette and wherein the second surface characteristic produces an air tight seal and a maximum coefficient of friction that generates a maximum frictional force in use when the pipette tip inner surface is in contact with the outer surface of the piston of a pipette, wherein the maximum frictional force is less than the static frictional force, thereby allowing the piston of the pipette to slide relative to the pipette tip inner surface while the pipette tip outer surface remains fixed to the interior surface of the elongated tip mounting shaft by action of the static frictional force.

2. The disposable pipette tip of claim 1, wherein there is no protruding structure on the pipette tip outer surface of the proximal end portion of the pipette tip.

3. The disposable pipette tip of claim 1, wherein the pipette tip outer surface does not engage any portion of the annular channel with a snap fit.

4. A pipette tip for use with an air displacement pipette having an elongated tip-mounting shaft, a piston, and an annular channel defined between the mounting shaft and the piston, the pipette tip comprising:
a liquid handling portion comprising an elongated, tubular liquid handling body with a first distal end and a first proximal end, and an orifice disposed at the first distal end;
a mount portion extending from the first proximal end of the liquid handling portion, the mount portion including a distal portion and a proximal end portion, the distal portion comprising a first wall thickness, the proximal end portion comprising a second wall thickness smaller than the first wall thickness and being between 0.1 mm and 0.4 mm, the proximal end portion having a length of at least 2 mm, the proximal end portion having a pipette tip outer surface comprising a first material and a first surface roughness defining a first surface characteristic, and wherein the proximal end portion also comprises a pipette tip inner surface, parallel to the pipette tip outer surface, and comprising the first material and a second surface roughness defining a second surface characteristic;
wherein the first surface characteristic produces a static frictional force in use when the pipette tip outer surface is in contact with the tip mounting shaft of a pipette and wherein the second surface characteristic produces an air tight seal and a maximum frictional force in use when the pipette tip inner surface is in contact with the piston of a pipette, wherein the maximum frictional force is less than the static frictional force.

5. The pipette tip of claim 4, wherein there is no protruding structure on the pipette tip outer surface of the proximal end portion of the pipette tip.

6. The pipette tip of claim 4, wherein the pipette tip outer surface does not engage any portion of the annular channel with a snap fit.

7. The pipette tip of claim 4, wherein the proximal end portion comprises a uniform cross section extending at least 2 mm from a terminal end of the proximal end portion.

8. The pipette tip of claim 4, wherein there is no structural protrusion on the pipette tip outer surface of the proximal end portion.

9. The pipette tip of claim 4, wherein the first and second surface characteristics are configured such that magnitudes of the maximum and static frictional forces allow the piston of the pipette to slide relative to the pipette tip inner surface while the pipette tip outer surface remains fixed to an interior surface of the elongated tip mounting shaft by action of the static frictional force.

10. The pipette tip of claim 4, wherein the proximal end portion comprises an intermediate step, dividing the proximal end portion into a distal part and a proximal part, the pipette tip outer surface being disposed on the distal part and the pipette tip inner surface being disposed on the proximal part.

11. The pipette tip of claim 10, wherein the proximal part comprises an outer diameter that is less than an outer diameter of the pipette tip outer surface.

12. A pipette tip for use with an air displacement pipette having a mounting shaft, and a piston, the pipette tip comprising:
a liquid handling portion comprising an elongated, tubular liquid handling body with a first distal end and a first proximal end, and an orifice disposed at the first distal end;
a mount portion extending from the first proximal end of the liquid handling portion, the mount portion including a distal portion and a proximal end portion, the distal portion comprising a first wall thickness, the proximal end portion comprising a second wall thickness smaller than the first wall thickness, the proximal end portion having a pipette tip outer surface, and wherein the proximal end portion also comprises a pipette tip inner surface, substantially parallel to the pipette tip outer surface, wherein there is no protruding structure on the pipette tip outer surface of the proximal end portion of the pipette tip.

13. The pipette tip of claim 12, wherein the second wall thickness is between 0.1 mm and 0.3 mm.

14. The pipette tip of claim 12, wherein the pipette tip outer surface does not include any surface features configured to engage any portion of a pipette with a snap fit.

15. The pipette tip of claim 12, wherein the proximal end portion comprises a uniform cross section extending at least 2 mm from a terminal end of the proximal end portion.

16. The pipette tip of claim 12, wherein there is no structural protrusion on the pipette tip outer surface of the proximal end portion.

17. The pipette tip of claim 12, wherein the proximal end portion comprises an intermediate step, dividing the proximal end portion into a distal part and a proximal part, the pipette tip outer surface being disposed on the distal part and the pipette tip inner surface being disposed on the proximal part.

18. The pipette tip of claim 17, wherein the proximal part comprises an outer diameter that is less than an outer diameter of the pipette tip outer surface.

19. The pipette tip of claim 17, wherein the second wall thickness is at least 0.1 mm, and the proximal end portion has a length of at least 2 mm.
